(19) United States
(12) Patent Application Publication
(10) Pub. No.: US 2009/0257048 A1
(43) Pub. Date: Oct. 15, 2009

(54) OPTICAL FIBER INSPECTION DEVICE AND METHOD THEREOF

(75) Inventors: Wen-Ping YU, Chung Ho City (TW); Tung-Po Chiu, Chung Ho City (TW)

Correspondence Address: Muncy, Geissler, Olds & Lowe, PLLC, P.O. BOX 1364, FAIRFAX, VA, 22038-1364, US

(73) Assignee: AMTRAN TECHNOLOGY CO., LTD.

(21) Appl. No.: 12/174,248

(22) Filed: Jul. 16, 2008

(30) Foreign Application Priority Data
Apr. 14, 2008 (TW) 097113496

(51) Int. Cl. G01N 21/958

(52) U.S. Cl. 356/73.1

(57) ABSTRACT

The present invention provides an optical fiber inspection device. The optical fiber inspection device is used to inspect an optical fiber. The optical fiber has a first termination and a second termination. The optical fiber inspection device includes a light emitter and an engagement portion. The first termination of the optical fiber can be detachably connected to the engagement portion so as to make the optical fiber to be coupled to the light emitted by the light emitter.

### BACKGROUND OF THE INVENTION

1. Field of the Invention

This invention relates to an optical fiber inspection device and the method thereof. More particularly, the invention relates to an optical inspection device and the method thereof which users can easily inspect whether the optical fiber is broken during laying the optical fiber.

2. Description of the Prior Art

Optical fibers which can be used for transmitting light are made of glass fibers or plastics fibers. The diameter of an optical fiber is only about 10 um, which is just a bit thicker than a hair. By being encapsulated into the plastic cladding, the optical fiber can be bent without breaking.

Compared with the conventional cable, the optical fiber have advantages such as high bandwidth, large communication capacity, less decay, far transmitting distance, small crosstalk, high transmission quality, resistance to electromagnet interference, high secrecy, small size, lightness, ease of laying and removing, abundant information, etc. Therefore, the optical fiber is good enough to substitute for the conventional cable to be the medium for communication transmission.

Although there are many advantages and characteristics, the optical fiber has some disadvantages. For example, the terminal processing of the optical fiber is hard to be handled, operations of splitting and coupling are complicated, and etc. Especially, the optical fiber is brittle and has low mechanical strength, so the bending radius of the optical fiber is not proper to be too small.

Moreover, because optical fibers are usually laid for a long distance, it is very important to diagnose the fault (otherwise it will be difficult to be fixed). Several ways for detecting whether an optical fiber is broken are as follows: (1) using a standard light source and an optical power meter, (2) using an optical time-domain reflectometer (OTDR), and (3) using the detect function embedded in transmission equipment.

The way (1) is performed to make the standard light source (generally the infrared region reserved for the use of communication) to emit light into a termination of the optical fiber and dispose the optical power meter at another termination of the optical fiber to observe whether the light has passed. If the power of the received light is too low, the optical fiber may be broken. The defect of this way is that we can only know whether the optical fiber is broken. As for the location of the breakage, it is unknown.

The way (2) is performed by emitting an optical pulse signal into the optical fiber with the optical time-domain reflectometer and detecting the reflected signal of the optical pulse signal. By measuring the strength and time of the reflected signal, the power consumptions and locations of all splice points and breakage points can be calculated. This is a more precise diagnostic tool; however, cost of the equipment is much higher.

The way (3) which uses the detect function embedded in transmission equipment is performed to show whether the connection of the optical fiber is in normal operation by alerting with indicator lights or software. Some kinds of equipment can change the transmission path automatically to repair themselves. By making the most of these inspection functions, problems can be rapidly discovered and solved while the system is running.

However, the costs of the above-mentioned optical fiber inspection equipment are too high. In consumer market, users can only afford the cost of the optical fiber. When the users buy optical fibers, they have no idea whether the optical fibers will break whiling being laid at home.

Accordingly, the major scope of the invention is to provide an optical inspection device and the method thereof to solve the foregoing problems. The structure of the optical fiber inspection device is simple so that the cost can be reduced and the optical fiber inspection device can be easily used. When users can afford the optical fiber inspection device, they can easily inspect whether the optical fiber is broken during laying the optical fiber by visual inspection. Thus, the users can inspect optical fibers themselves without on-site services provided by professional constructors, so as to save additional cost of inspecting the optical fibers.

### SUMMARY OF THE INVENTION

A scope of the invention is to provide an optical fiber inspection device. The optical fiber inspection device is used for inspecting an optical fiber. The optical fiber has a first termination and a second termination. The optical fiber inspection device includes a light emitter and an engagement portion. The light emitter, by being driven, is used for emitting a light. The first termination of the optical fiber is detachably connected to the engagement portion, so as to make the optical fiber to be coupled to the light emitted by the light emitter. The light then enters the optical fiber via the first termination.

Another scope of the invention is to provide an optical fiber inspection method. The optical fiber inspection method is used for inspecting an optical fiber by an optical fiber inspection device. The optical fiber has a first termination and a second termination. The optical fiber inspection device includes a light emitter and an engagement portion. The optical fiber inspection method includes the following steps. Firstly, the optical fiber inspection method is performed to detachably connect the first termination to the engagement portion, so as to make the optical fiber to be coupled to the light emitter. Then, the optical fiber method is performed to drive the light emitter to emit a light into the optical fiber via the first termination.

In additional, another scope of the invention is to provide an optical fiber inspection method. The optical fiber inspection method is used for inspecting an optical fiber by an optical fiber inspection device. The optical fiber has a first termination and a second termination. The optical fiber inspection device includes a light emitter and an engagement portion. The optical fiber inspection method includes the following steps. Firstly, the optical fiber inspection method is performed to detachably connect the first termination to the engagement portion, so as to make the optical fiber to be coupled to the light emitter. Then, the optical fiber method is performed to drive the light emitter to emit a light into the optical fiber via the first termination. Finally, the optical fiber method is performed to check whether the light is emitted from the second termination.

According to the optical fiber inspection device with simple structure and the simplified optical fiber inspection methods of the invention, a user can easily inspect whether the optical fiber is broken during laying the optical fiber by visual inspection. Thus, the users can inspect optical fibers themselves without on-site services provided by professional constructors, so as to save additional cost of inspecting the optical fibers.

The advantage and spirit of the invention may be understood by the following recitations together with the appended drawings.

### BRIEF DESCRIPTION OF THE APPENDED DRAWINGS

FIG. 1 is a cross-sectional view illustrating the optical fiber inspection device according to an embodiment of the invention.

FIG. 2 is a cross-sectional view illustrating the optical fiber inspection device according to another embodiment of the invention.

FIG. 3 is a flow chart showing the optical fiber inspection method according to an embodiment of the invention.

### DETAILED DESCRIPTION OF THE INVENTION

The scope of the invention is to provide an optical fiber inspection device and the method thereof. According to the optical fiber inspection device with simple structure and the simplified optical fiber inspection methods of the invention, it is easy to inspect whether the optical fiber is broken during laying the optical fiber. With the example and explanations followed, the features and spirits of the invention will be hope-fully well described.

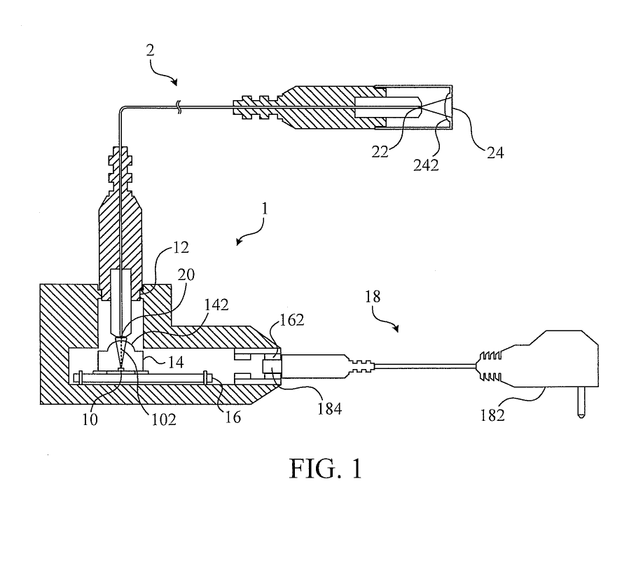

Please refer to FIG. 1 which is a cross-sectional view illustrating the optical fiber inspection device 1 according to an embodiment of the invention. The optical fiber inspection device 1 includes a light emitter 10 and an engagement portion 12. An optical fiber 2 has a first termination 20 and a second termination 22. The light emitter 10, by being driven, can be used for emitting a light. The first termination 20 of the optical fibers 2 can be detachably connected to the engagement portion 12, so as to make the optical fiber 2 to be coupled to the light emitted by the light emitter 10. The light then enters the optical fiber 2 via the first termination 20.

In an embodiment, the light emitter 10 can be, but not limited to, a laser diode (LD) or light emitting diode (LED). Any light emitters which can emit visible light can be applied to the invention presented.

If the light emitter 10 is a light emitting diode, the light emitter 10 can be packaged by a polymeric material 14 (e.g., epoxy resin). The light emitted by the light emitter 10 includes an optic axis 102.

It is notable that in order to make the light emitted by the light emitter 10 to be coupled into the optical fiber 2 as much as possible, a first lentoid contour 142 can be formed on the polymeric material 14 where the optic axis 102 passes through. Thus, the light can be focused into the optical fiber 2 by the first lentoid contour 142, as shown in FIG. 1.

Besides, while buying the optical fiber used in the optical communication system, two caps are usually provided to protect two terminations of the optical fiber. In this invention, in order to clearly inspect that whether the light emitted by the light emitter 10 can be emitted out of the second termination 22 of the optical fiber 2, the optical fiber 2 can further include a lucent cap 24 in an embodiment. The second termination 22 of the optical fiber 2 is detachably engaged to the lucent cap 24. A second lentoid contour 242 can be formed at the bottom of the lucent cap 24. The light can be focused by the second lentoid contour 242 and be observed by visual inspection when the light emitted by the light emitter 10 is emitted out of the second termination 22 of the optical fiber 2, as shown in FIG. 1. In an embodiment, the foregoing lucent cap 24 can be totally transparent. Certainly, in order to make a Conspicuous contrast with the light emitted from the second termination 22 and to be easily inspected by users, the lucent cap 24 can also be other appropriate colors, so as to make an obvious comparison.

In an embodiment, if the coupling precision between the optical fiber 2 and the light emitted by the light emitter 10 is good enough, the light output of the light emitter 10 is not necessary to be large, in order to achieve the goal of inspecting the optical fiber of the invention. Meanwhile, the light emitter 10 can be driven to emit light by a battery with less current.

On the other hand, if the goal of inspecting the optical fiber of the invention can be achieved when the coupling precision between the optical fiber 2 and the light emitted by the light emitter 10 is not so good, the assembling cost can be reduced effectively.

Therefore, in another embodiment, the optical fiber inspection device 1 according to the invention can further include a transformer 18. The transformer 18 includes a plug 182 and a power output terminal 184. The optical fiber inspection device 1 further includes a circuit board 16 and a power input terminal 162. The light emitter 10 is electrically connected to the circuit board 16. By plugging the plug 182 of the transformer 18 into a general outlet which provides 110V or 220V and connecting the power output terminal 184 of the transformer 18 to the power input terminal 162 of the optical fiber inspection device 1, the direct current outputted by the transformer 18 can feed the light emitter 10 through the circuit board 16, and the light emitter 10 then emits the light, as shown in FIG. 1.

It needs to be explicated that the light output of the light emitter 10 can be greatly increased by adopting external power supply. Therefore, even the coupling precision between the optical fiber 2 and the light emitted by the light emitter 10 is not so good, the increased light output also can make enough light to enter the first termination 20 of the optical fiber 2. Thus, not only the goal of inspecting the optical fiber of the invention can be achieved, but also the assembling cost can be reduced effectively.

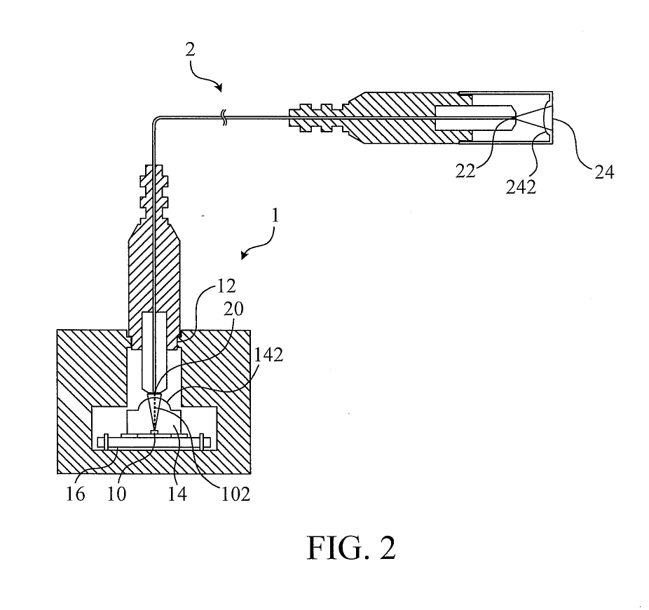

Besides, please refer to FIG. 2 which is a cross-sectional view illustrating the optical fiber inspection device 1 according to another embodiment of the invention. In this embodiment, the light emitter 10 according to the invention can be, but not limited to, the transmitter optical subassembly (TOSA) in a video player, e.g., the TOSA for transmitting video/audio signals at the DVD player terminal, or the TOSA for transmitting control signals at TV terminal.

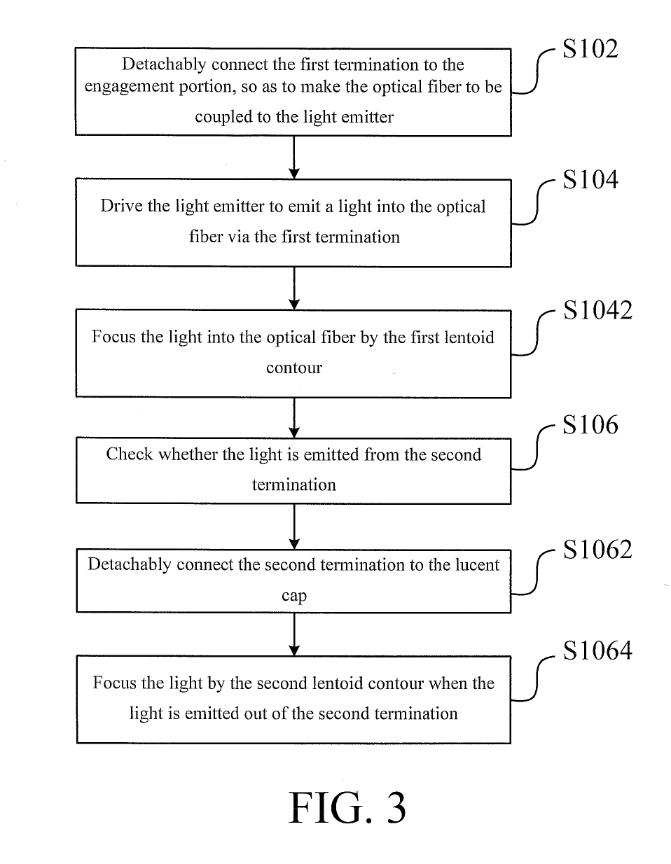

Please refer to the FIG. 3. FIG. 3 is a flow chart showing the optical fiber inspection method according to an embodiment of the invention. Please also refer to FIG. 1 and FIG. 2 and base on the structure of the foregoing optical fiber inspection device 1.

Firstly, the optical fiber inspection method according to the invention is used for inspecting an optical fiber with the above-mentioned optical fiber device 1. The optical fiber has the first termination 20 and the second termination 22. The optical fiber device 1 includes the light emitting 10 and the engagement portion 12, as shown in FIG. 1 and FIG. 2. The optical fiber inspection method according to the invention presented includes the following steps.

At first, according to the optical fiber inspection method of the invention, step S102 is performed to detachably connect the first termination to the engagement portion, so as to make the optical fiber to be coupled to the light emitter. Next, step S104 is performed to drive the light emitter to emit a light into the optical fiber via the first termination. Finally, step S106 is performed to check whether the light is emitted from the second termination. Accordingly, if the light emitted by the light emitter can be seen by a user from the second termination of the optical fiber, it represents that the optical fiber has no problem. Contrarily, if the light emitted by the light emitter cannot be seen from the second termination of the optical fiber, it implies that the optical fiber is broken. It is considerable to fix the optical fiber or change a new one directly.

In order to coupling the light emitted by the light emitter into the optical fiber as much as possible, the light emitter can be packaged by a polymeric material (e.g., Epoxy Resin) in an embodiment. The light emitter has an optic axis. A first lentoid contour is formed on the polymeric material where the optic axis passes though. The optical fiber inspection method according to the invention can further include step S1042, and step S1042 is performed to focus the light into the optical fiber by the first lentoid contour.

Similarly, in order to clearly inspect whether the light emitted by the light emitter can be emitted from the second termination of the optical fiber, the optical fiber can further include a lucent cap. It is notable that a second lentoid contour can be formed at the bottom of the lucent cap. Therefore, according to the optical fiber inspection of the invention, step S1062 is performed to detachably connect the second termination to the lucent cap. Then, step S1064 is performed to focus the light by the second lentoid contour when the light is emitted out of the second termination. By performing the steps to achieve the effect of focusing described above, a user can easily inspect whether the optical fiber is broken during laying the optical fiber by visual inspection.

According to the preferred embodiment, a user can easily inspect whether the optical fiber is broken during laying the optical fiber of the invention by visual inspection. Thus, the users can inspect optical fibers themselves without on-site services provided by professional constructors, so as to save additional cost of inspecting the optical fibers. And, the optical fiber inspection device and the method thereof can be applied with the TOSA in a video player.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical fiber inspection device for inspecting an optical fiber, the optical fiber having a first termination and a second termination, the optical fiber inspection device comprising:
a light emitter for emitting, by being driven, a light; and
an engagement portion;
wherein the first termination of the optical fiber can be detachably connected to the engagement portion, so as to make the optical fiber to be coupled to the light emitted by the light emitter and the light then enter the optical fiber via the first termination.

2. The optical fiber inspection device of claim 1, wherein the light emitter is a light emitting diode.

3. The optical fiber inspection device of claim 2, wherein the light emitter is packaged by a polymeric material, the light emitter has an optic axis, a first lentoid contour is formed on the polymeric material where the optic axis passes through, and the light is focused into the optical fiber by the first lentoid contour.

4. The optical fiber inspection device of claim 1, wherein the optical fiber further comprises a lucent cap, and the second termination is detachably engaged to the lucent cap.

5. The optical fiber inspection device of claim 4, wherein a second lentoid contour is formed at the bottom of the lucent cap, and the light can be focused by the second lentoid contour when the light is emitted out of the second termination.

6. The optical fiber inspection device of claim 1, wherein the optical fiber inspection device can be a transmitter optical subassembly in a video player.

7. An optical fiber inspection method for inspecting an optical fiber by an optical fiber inspection device, the optical fiber having a first termination and a second termination, the optical fiber comprising a light emitter and an engagement portion, the optical fiber inspection method comprising the steps of:
detachably connecting the first termination to the engagement portion, so as to make the optical fiber to be coupled to the light emitter; and
driving the light emitter to emit a light into the optical fiber via the first termination.

8. The optical fiber inspection method of claim 7, wherein the light emitter is a light emitting diode.

9. The optical fiber inspection method of claim 8, wherein the light emitter is packaged by a polymeric material, the light emitter has an optic axis, a first lentoid contour is formed on the polymeric material where the optic axis passes through, and the optical fiber inspection method further comprises the step of:
focusing the light into the optical fiber by the first lentoid contour.

10. The optical fiber inspection method of claim 7, wherein the optical fiber further comprises a lucent cap, and the optical fiber inspection method further comprises the step of:
detachably connecting the second termination to the lucent cap.

11. The optical fiber inspection method of claim 10, wherein a second lentoid contour is formed at the bottom of the lucent cap, and the optical fiber inspection method further comprises the step of:
focusing the light by the second lentoid contour when the light is emitted out of the second termination.

12. An optical fiber inspection method for inspecting an optical fiber by an optical fiber inspection device, the optical fiber having a first termination and a second termination, the optical fiber including a light emitter and an engagement portions the optical fiber inspection method comprising the steps of:
detachably connecting the first termination to the engagement portion, so as to make the optical fiber to be coupled to the light emitter;
driving the light emitter to emit a light into the optical fiber via the first termination; and
checking whether the light is emitted from the second termination.

13. The optical fiber inspection method of claim 12, wherein the light emitter is a light emitting diode.

14. The optical fiber inspection method of claim 13, wherein the light emitter is packaged by a polymeric material, the light emitter has an optic axis, a first lentoid contour is formed on the polymeric material where the optic axis passes through, and the optical fiber inspection method further comprises the steps of:
focusing the light into the optical fiber by the first lentoid contour.

15. The optical fiber inspection method of claim 12, wherein the optical fiber further comprises a lucent cap, and the optical fiber inspection method further comprises the steps of:
detachably connecting the second termination to the lucent cap.

16. The optical fiber inspection method of claim 15, wherein a second lentoid contour is formed at the bottom of the lucent cap, and the optical fiber inspection method further comprising the steps of:
focusing the light by the second lentoid contour when the light is emitted out of the second termination.
